(19) United States
(12) Patent Application Publication
(10) Pub. No.: US 2016/0018298 A1
(43) Pub. Date: Jan. 21, 2016

(54) Apparatus and process for growth, maintenance, detection and /or examination of items in fluidic test samples

(71) Applicants: Geoffrey N. Roth, Goshen, IN (US); Jonathan N. Roth, Goshen, IN (US)

(72) Inventors: Geoffrey N. Roth, Goshen, IN (US); Jonathan N. Roth, Goshen, IN (US)

(21) Appl. No.: 14/120,969

(22) Filed: Jul. 15, 2014

(51) Int. Cl. G01N 1/28

(52) U.S. Cl. CPC G01N 1/28

(57) ABSTRACT

A testing apparatus for fluidic test samples is provided having a card-like base member formed from non-absorbent, non-toxic material(s), without any gelling agent in the area where the test sample is to be deposited, and a separate, thin film top piece to be applied as a manipulable cover to the base member once the test sample is deposited on the base member. The top piece contains the matrix agent(s) for securing the test sample to the base member, such that the gelling agent(s) is applied to the test sample substantially simultaneously with dispersion of the test sample over the base member, as caused by the contact with and compression by and/or through the top piece.

### CROSS REFERENCE TO RELATED PATENT APPLICATION

This application is a continuation in part of U.S. patent application Ser. No. 14/120,204, filed on May 5, 2014.

### FIELD OF THE INVENTION

The present invention relates to apparatus and process of examining samples of items contained within a fluid, especially for growing, maintaining, detecting, and/or examining biological entities, such as micro-organisms, bacteria and the like, and, more particularly, to methods of detecting enzyme reactions which are indicative of the presence of bacteria and other micro-organisms.

### BACKGROUND OF THE INVENTION

The present invention is in part considered to be an improvement upon Petrifilm products offered for sale by 3M Corporation. The present invention is in part also considered to be an improvement of the inventions proposed in U.S. Pat. Nos. 4,565,783, 5,089,413, 5,232,838, 5,147,801, 5,364,766, 5,409,838, 5,837,482, 5,601,998, 6,632,661, 6,649,406 and the like.

In general, prior apparatus and processes for examination of micro-organisms involved transferring samples of the micro-organism which were entrained within a fluid, such as water, to a surface, covering the fluid sample in a manner which caused the fluid sample to spread out over the surface and be of a reduced thickness, and then to visually examine the fluid to see what it contained. Magnification devices and dyes have been used to aid in that regard, such as in a standard microscopic slide examination. However, where the density of certain micro-organisms was small in the test sample (and/or not easily detectable visually) and it was desired to test to find those specific micro-organisms, nutrients have been applied to a surface upon which the fluidic test sample was placed, in order to cause at least the specific micro-organisms of interest to grow more rapidly and increase their detectability, such as in a standard Agar plate or Petri dish examination.

Petrifilm products, and the process of its use, have been marketed as an improvement upon those prior apparatus and processes since they reportedly can facilitate more rapid examination of a large number of test samples at lower costs, particularly when testing foodstuffs and water supplies. Petrifilm products typically require first the use of an integrally formed top film which should be “rolled slowly down” over the test sample after the test sample is placed on the base surface, and then, secondly, the use of a plastic spreader to distribute the test sample more widely and/or avoid the formation of air bubbles within the test sample. This process of use is described more fully at http://en.wikipedia.org/wiki/Petrifilm.

However, Petrifilm products and process are often not as efficient and/or cost effective as would be desirable, particularly in automated detection systems and/or when applied to high volume, rapid testing. In part, these limitations can result because of the particular detection methodology used with Petrifilm products, and in particular, the coatings used in connection with the products, which interact with the items contained within the fluidic sample. The present applicants have addressed solutions and improvements in that regard elsewhere (including in other U.S. Patents) by the use of improved chromagenic, fluorogenic, and/or other detection methods, products, and different coatings which facilitate and enhance those detection methods. However, these limitations in Petrifilm products and process also result because of the nature of Petrifilm product itself and its recommended usage. The present application addresses separately improvements in that regard, and particularly improvements which can be used in conjunction with the previously disclosed chromagenic, fluorogenic, and/or other detection methods.

Accordingly, it is an object of the present invention to provide an improved method of detecting micro-organisms and the like. Other objects include the provision of such detection apparatus and methods which:
a. are less expensive to use, more accurate, and produces faster results,
b. produce a greater volume of results within a given time period,
c. require less storage space prior to use,
d. have the capacity of ready application of multiple testing sequences,
e. have a longer shelf life prior to use, and
f. have greater versatility in the nature and extent of the testing to be done.

### SUMMARY OF THE INVENTION

These and other objects of the present invention are obtained by a testing apparatus for fluidic test samples having a card-like base member formed from non-absorbent, non-toxic material(s), which may be coated with a gelling agent, if the agent is not in “a sufficient amount . . . so that a predetermined quantity of water or/an aqueous sample, e.g. 1-3 milliliters . . . will form a gel having a viscosity of about 1500 cps or more when measured at 60 rpm with a Brookfield Model L V F viscometer at 25° C.” (U.S. Pat. No. 4,565,783. P.5, lines 6-9), in the area where the test sample is to be deposited, and a separate, thin film top piece may be applied as a cover to the base member once the test sample is deposited on the base member. The top piece may be coated with one or more “matrix agent(s)”, in this specification defined as an agent from a group comprising different gums, gelling agents, and thickening agents. The matrix agent may be used to secure test sample between the base member and the top piece, such that the matrix agent(s) can be applied to the test sample substantially simultaneously, facilitating dispersion of the test sample over the base member, as caused at least in part by the forces involving said application of the top piece.

This arrangement permits manufacturing optimization, since the top and base constructions and materials can be selected independently and without need for interconnection. This arrangement also streamlines the test sample examination process since it typically permits the test sample to be spread over the base with improved dispersion and/or more quickly. The present invention also facilitates automation of the test sample examination process since the top and base can be stored and manipulated separately, and the top can be applied to the sample by a simple vertical motion, rather than a “rolling” process. When used with respect to many of the applicants' chromagenic and/or other detection inventions, for example, the present invention is not usually adversely affected by gas bubble formation within the test sample. In addition, the present invention can allow for the top piece to be removed and additional testing of the same test sample to be conducted merely by application of a different top piece or by easy removal of a portion of the test sample to another base member.

Other objects, advantages, and novel features of the present invention will become readily apparent to those of skill in the art from the following detailed description and claims.

### BRIEF DESCRIPTION OF THE DRAWING

FIG. 1 shows a schematic side view of a preferred embodiment of the present invention.

### DESCRIPTION OF PREFERRED EMBODIMENTS

In the apparatus and process for growth, maintenance, detection and/or examination of items in fluidic test samples of this invention, said items are often microbial.

The present invention is particularly applicable to current testing requirements in the medical, water monitoring, and food and beverage industry with respect to detection of bacteria, various pathogens, and other microorganisms and the like. This invention facilitates testing as to the presence or absence of the items to be detected as well as quantitative testing as to the volume of such items and/or differentiation of the various types of items to be detected. This invention is also often suitable to use in educational and scientific analysis or detection systems for such items.

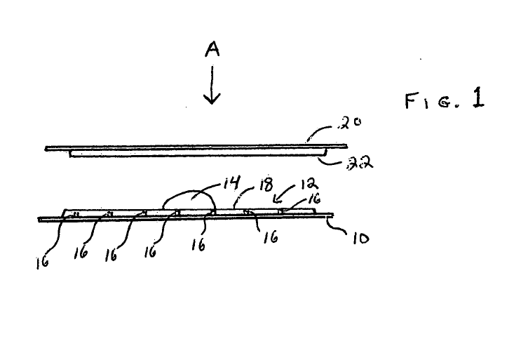

FIG. 1 shows schematically the structure of a preferred embodiment of the present invention, with the components not drawn to scale, but rather enlarged for ease of understanding of the invention details. FIG. 1 shows a base member 10 which can be formed as a card-like element of relatively thin material. Base member 10 has a surface 12 for receiving, supporting, and/or and holding a test sample 14. The surface (12) may indicate the upper side of 10, or a separate coating. Base member 10 can be of any dimension suitable for the specific nature of testing or examination to be conducted, but, as an example, for examination of 1 mL of fluidic material, a preferred dimension of 3.5×4.0 inches×5 mils thickness is advisable for certain standard incubation and examination equipment and practices. Various materials, alone and/or in combination, are suitable for composition of base member 10, comprising, for example, plastics, glass, metal foils, or paper, but preferably, the material should usually be non-absorbent with respect to the fluid to be received on it and examined. Polyester compositions have been found to be especially useful in certain applications. The base member may be opaque, translucent, or transparent, as desired in a particular examination process. Similarly, the base member may be of any desired color (such as for a particular contrast with the anticipated target materials), although white has been found especially suitable when certain types of chromogenic/fluorogenic methods are used to examine the treated and/or resultant test sample. Also, in many applications, it will be desirable for the base member to be non-toxic or reactive with respect to the items to be tested, examined, maintained, etc. within the test sample.

Preferably, indicia 16 are formed or printed on surface 12 to aid in examination of test sample 14. Indicia 16 can, for example, be embossments slightly raised from surface 12 (as shown in FIG. 1) or, alternatively, scored or pressed into surface 12, or alternatively, merely printed as a film on surface 12, or alternatively (particularly if base member 10 is wholly or partially transparent) may be printed onto the underside of base member 10. Indicia 16 may, for example, be formed to show a grid pattern in the conventional manner over surface 12 which can be perceived under ordinary lighting and/or under the particular illumination used in examination of the test sample. Indicia may also include printed material for noting vital information about the test sample and/or the examination conducted with respect to it.

Surface 12 may not, in certain embodiments, include a gelling agent, as described on page 4, fixed to its surface, at least in the area to which test sample 14 is applied and held. One or more such gelling agents can be placed elsewhere on surface 12. However, in some preferred embodiments, there is no significant contact of such a gelling agent connected to the center card area, with the test sample prior to contact of the test sample with top piece 20, unless such a gelling agent is part of the test sample, e.g.—some dressings and ice creams. By “significant contact,” it should be understood, that in some especially preferred embodiments of the present invention, a gel would not be formed, prior to contact of the test sample with the top piece 20, which inhibits ready dispersion of the test sample over surface 12. However, surface 12 may optionally be a coating (surface 18) comprising materials selected according to the development, maintenance, incubation, and/or examination desired for testing of a particular sample. That coating may, for example be comprised of an adhesive agent which holds a powder in place and/or has materials mixed into, embedded, and/or entrained with the adhesive agent, with or without buffers, antibiotics, inhibitors, nutrients, chromogenic and/or fluorogenic substrates, inducers, etc., as desired according to the particular nature of the examination, maintenance, and/or use of the present invention. In many applications, forming the base member according to the principles of the present invention permits those base members to be readily stackable and storable for long periods of time without significant degradation of performance.

Further, the present invention can be used in certain applications where one or more absorbent substance(s) is applied to the fluidic test sample, instead of, or with, using matrix agent(s). Again, the principles of the present invention would teach, in certain such embodiments for example, that significant production of the viscosity of the fluidic test sample be deferred until the physical dispersion is commenced by use of top piece 20. In other embodiments, absorbent materials may be used to construct base member 10, but it is preferred that those materials do not significantly reduce the necessary extent of dispersion of the fluidic test sample, according to the needs of the particular application involved.

Test samples suitable for use with the present invention may have items to be tested entrained within them prior to deposition of the test sample on base member 10 or 12. Alternatively, the items to be tested, which may comprise matrix agents, may be deposited onto base member 10 and then combined with a suitable fluidic substance (e.g.- a powder can be applied to surface 12 and then water added on top of the powder and into which the powder is absorbed). It will suffice merely that, prior to application of top piece 20, the material to be tested is of a nature such that forces involved in the application of top piece 20 contribute to causing dispersion of the material over a larger area of surface 10 or 12 than the area of initial deposition.

Also, in examples stated herein the matrix agent(s) is often envisioned as being used to connect the top piece 20 to base member 10. However, a matrix agent used with the present invention can have additional functions as well, such as to help confine the location of the test sample and/or create the area of confinement of the test sample.

Top piece 20 may be formed from a variety of conventional materials (either alone or in combination) commonly found in test sample examination devices. Top piece, 20 is preferably transparent plastic or a thin, clear film material having sufficient rigidity to facilitate manipulation, placement, and/or uniform compression of top piece 20 onto the surface of base member 10 or 12. Its dimensions may vary from those of the base member, and it may, for example, slightly over or underlap the base member. In many instances, it has been found desirable to make the dimensions of the top piece similar to those of the base member, but a slight variation can be helpful to facilitate later removal of the top piece. The thickness of the top piece may vary so long as it does not inhibit significantly the examination process. Similarly, with the present invention it is not required that the top piece be impermeable to gas, particularly where gas bubbles are not used in the testing process (as, for example, where certain chromogenic materials are used as a basis of examination).

Where the top piece is desired to have permanent or more secure adherence to the base member, adhesive material which, in preferred embodiments, is not toxic to item(s) to be tested may be used, for example, on one or more sides of top piece 20 to engage the base member. This adhesive may, for example, be a conventional acrylic or silicone material. It should be understood, however, that in this context, “permanent” is a relative term, comparing the duration and/or adhesiveness of the gelling agent with this other adhesive material. In other embodiments, such as where top piece 20 is intended to be later and/or readily removed from the base member, such as to allow access to the test sample for additional testing after incubation, or where the application of top piece 20 to the test sample is to be reversed, such an adhesive does not need to be used in every instance.

Top piece 20 may include on its lower surface a coating (22) of guar gum and/or one or more other matrix agents (e.g.-nutrients, inhibitors, inducers). This matrix agent may be retained in place via an additional, conventional adhesive or applied directly, according to its own adhesive characteristics. Coating 22 may, for example, also comprise a mixture of nutrients to promote growth of organisms sought to be detected and/or other diagnostic materials (e.g.—buffers, inhibitors including antibiotics, inducers) which may be found to be desirable to apply to the test sample in a given instance. The coating (22) may comprise dehydrated media (e.g.—dehydrateed growth media). The finished nature of coating 22 may be dry and/or dehydrated in nature so as to promote longer shelf life. In particular applications, it may be desirable to store, transport, or incubate either the base members and/or the top piece with a separation plate between stacked elements. The separation plates may be, for example, non-adhesive and non-toxic with respect to the base member, top piece, and items to be tested. The separation plates may, for example, be similarly formed as card-like members which can be easily manipulated by hand or automated devices.

In alternative embodiments, top piece 20 may initially be formed as a portion of base member 10, separated by a scoring or serration which allows the top piece to be removed from the base member and/or folded over upon it during use. Further, in alternative embodiments, the top piece may include additional or alternative indicia 16. In the latter embodiments, indicia 16 would not need to be formed on base member 10.

To use the apparatus of the present invention, base member 10 is typically placed on a flat, level surface. A conventional pipette, for example, would be usable to deposit a volume of test sample 14 onto surface 10 or 12. This can be done by hand or by an automated device, as desired in a given instance. Thereafter, top piece 20 would be lowered onto the test sample in the direction of arrow A in FIG. 1, preferably centered over the test sample, such that its contact with the test sample, and settling of the top piece toward the base member, would contribute to the test sample to disperse evenly in a generally circular pattern on surface 10 or 12. The present invention does not require that the test sample be spread or dispersed over the entire side of base member 10. In certain applications it may be sufficient for surface area of 12 to be smaller than the entire top side of base member 10, for example.

This application of the top piece to the test sample on base member 10 can be readily done by hand or by an automated device. In those embodiments where top piece 20 is formed integrally with base member 10, the top piece is folded, rolled over, or otherwise positioned onto the test sample once the test sample is deposited onto the base member. It should be understood, that in preferred application of this process, it is thought that not only the weight of top piece 20 determines the dispersion of the test sample, but rather, forces including the total application of compressive force applied by and/or through top piece 20 to the test sample, taking into account the structural and chemical characteristics of the fluidic test sample itself and the nature of the examination, etc. desired of the test sample contents.

The matrix agent(s) is, as is conventional, used to create a matrix (e.g.-upon absorption with aqueous compounds of fluid from test sample 14) that may essentially retain the items to be tested (a target micro-organism, for example) in place with respect to the base member and/or is used to keep top piece 20 connected to base member 10. However, since with the present invention the top piece may provide a matrix (e.g.—gelling agent, the time elapsed between deposition of the test sample onto base member 10 and the application of the top piece does not permit significant increase in viscosity within the test sample which inhibits distribution of the test sample over a larger portion of the base member than results from said deposition of the test sample. In practical effect, the application of the top piece to the test sample to contribute to causing additional spreading of the test sample over the base member can occur substantially simultaneously with the introduction of the gelling agent to the test sample. In this way, premature viscosity which can inhibit ready dispersion of the fluidic test sample over base member 10 or 12 may be avoided.

In the description of preferred embodiments thus far, emphasis has been given to use of the present invention in the context of testing samples for micro-organisms. However, the present invention can also be used for examination of fluidic samples containing other items therein, especially where a matrix agent is to be employed to retain the treated and/or reacted fluid sample between two surfaces during the examination process, and/or to connect two supporting surfaces together with a testing sample there between.

In particular embodiments of the present invention, the matrix/nutrient layer between the top piece and the bottom piece contains the CFUs (colony forming units) of the target organisms and can be peeled off of the base piece so that individual colony portions of those organisms can be removed for transfer to another culture medium. Also, by segmenting the top piece, individual CFUs can be subjected to test solutions to easily determine if they are positive or negative for those test solutions. Further, the entire top piece containing CFUs may be flooded with reagent material or laid on a pad soaked with reagent material to determine more about the nature of the entire CFU population of that test sample.

Using a membrane filter (MF) Method, 50 CFUs of Escherichia coli in 50 ml of sterile water can be filtered. The amount of test water and its contents may be variable. The test membrane (can be one of various commercially available brands) holding the Escherichia coli CFUs can be placed on the base member. Use of the present invention may be with membrane filtration methods and/or Microtrap™ methods. 1 ml of sterile water may be placed either on top of the membrane, on the bottom piece under the membrane, or both. There may be a permeable pad placed under the membrane. A membrane filter or other filter may be used as the test membrane.

The Microtrap™ Method may be done in a similar manner, once the microbes are fixed on a commercially available membrane, however water and/or media may be added to the bottom piece and/or, to any permeable pad used, and/or to the membrane, depending on preference. The top piece is then positioned on top of the membrane, with incubation following. Colony counting is readily achieved thereafter. A membrane filter or other filter may be used as the test membrane.

As part of this invention, the 3M and Neogen products, Petrifilm and Neofilm, may be used. For instance, the membrane supporting the microbes may be put on to the top surface of the base portion of either test device type and water may be added before and/or after this. Utilizing these two device types, the Microtrap Method may be also used by putting a permeable pad and/or membrane on the same base surface of the other product as above and then putting the test sample on it. Both Petrifilm and Neofilm may be used, with or without MF and Microtrap Methods, using KwikCount method as an aspect of this invention.

The present invention is usable with fluorescent testing. For example, a nutrient mix containing 5-bromo-4-chloro-indolyl-B-D-glucuronide (X-gluc) as the only chromogenic enzyme substrate may be modified by adding or substituting 6-chloro-indolyl-B-D-glucuronide. This mix may be present on the top piece 20. When this top piece is used with a bottom piece and a test sample containing Escherichia coli and allowed to incubate at an appropriate temperature (i.e. 35 celsius) for 8-10 hours, the countable Escherichia coli CFUs can be detected as fluorescent colonies when illuminated with a long wave UV light source.

Additional applications of the present invention can use a middle piece (e.g. cellulose) to provide a test area of uniform surface area, identical from test to test to facilitate counting procedures, as an alternative to merely applying a fluidic test sample to the bottom piece and then applying the top piece. For example, when the fluidic sample is applied to the bottom piece, a middle piece formed from an inert absorber and area restrictor may be then applied to the sample, prior to application of the top piece.

Middle pieces may be made from Whatman Grade 44 cellulose or similar substances without any additives. In a preferred embodiment, the middle piece(s) are placed onto the bottom piece card(s) 10, and to each middle piece is added an aqueous inoculum containing Escherichia coli and Enterobacter aerogenes (1 mL of inoculum for each middle piece). The inoculum spreads and further covers the middle pieces. The top pieces are then applied to the middle pieces. Initially, air bubbles may be observed, but those may later disappear. The test samples are them placed into an incubator set at 35 degrees C. and allowed to incubate for 8-10 hours. Depending upon the top piece powder formulation, countable Escherichia coli CFUs are then visible in either or both ambient or long wave UV lighting. Fluorescence may indicate that the CFUs were possibly visible at an earlier time.

A Styrofoam or other suitable ring type barrier may be added to the base surface 10 or 12 to form a neater area of test material confinement.

Accordingly, the present invention has been described herein with respect to certain preferred embodiments, but the spirit and scope of this invention are limited only by the scope of the following claims:

What is claimed is:

1. An apparatus for facilitating examination of fluidic test samples, comprising:
a base surface for receiving and supporting at least one test sample, the base surface having no significant gelling agent adhered thereon in the area where the test sample is to be received, and
a top piece having a Matrix agent thereon, and being configured to be placed over the base surface after the test sample is deposited on the base surface and contributing to cause the test sample to spread over the base surface.

2. The apparatus according to claim 1 wherein the top piece is separate and removable from the base surface.

3. The apparatus according to claim 1 where in the top piece is formed as an extension of the base surface which is foldable over onto the base surface.

3. The apparatus according to claim 1 where in the top piece is attached to the base surface, but not in its entirety.

4. The apparatus according to claim 1 wherein the base surface is formed to be stackable with other base surfaces during storage or non-use.

5. The apparatus according to claim 1 wherein the base surface is coated with non-gelling agent materials to aid in examination of test sample prior to dispersion of the test sample over the base surface.

6. The apparatus according to claim 5 wherein base surface is formed from a material which is non-absorbent with respect to the test sample to be deposited on the base surface.

7. The apparatus according to claim 6 where the base surface is formed from material with is also non-absorbent with respect to any of the coatings on the top piece or the result of interactions between the test sample and the coatings on the top piece.

8. The apparatus according to claim 1 wherein the top piece is coated with dehydrated media.

9. The apparatus according to claim 1 wherein the base surface includes indicia thereon to aid in examination of resulting occurrences in the test sample.

10. The apparatus according to claim 1 wherein the apparatus is readily movable once the test sample is received to facilities for incubation of any material within the test sample or to facilities for examination of the test sample at a later point in time.

11. The apparatus according to claim 1 as used in the process of examining fluidic test samples containing material wherein at least one sample is placed on the base surface and then the top piece is applied to the test sample which is on the base surface such that the test sample spreads over a larger portion of the base surface.

12. The apparatus according to claim 11 wherein supplemental spreading of the test sample once the top piece is in place is not employed in the process.

13. The apparatus according to claim 11 where the top piece is applied to the test sample substantially simultaneously with the application of the matrix agent to the test sample.

14. The apparatus according to claim 1 wherein the test sample comprises microbial entities on the upper surface of a membrane or other filter, and fluid is added to the apparatus before and/or after the membrane is positioned.

15. The apparatus according to claim 1, wherein a membrane or other filter is positioned on to the base surface and the test sample is deposited on the membrane.

16. The apparatus according to claim 14, wherein a permeable pad is used under the membrane or other filter.

17. The apparatus according to claim 15 wherein a permeable pad is used under the membrane or other filter.

18. The apparatus according to claim 14 wherein the bottom piece is coated with any desired gelling agent and any type of membrane is used.

19. The apparatus according to claim 15 wherein the bottom piece is coated with any desired gelling agent and any type of membrane is used.
